(19) United States
(12) Patent Application Publication
(10) Pub. No.: US 2006/0229867 A1
(43) Pub. Date: Oct. 12, 2006

(54) Apparatus and method for deterministically constructing multi-lingual text questions for application to a data source

(75) Inventors: Paul Stuart Brownsey, Paris (FR); Stephen Gary Williams, Avon (FR); Nicholas Guy Kellet, Kelowna (CA); Steve Kopp, Paris (FR); Luke William Evans, West Vancouver (CA)

Correspondence Address: COOLEY GODWARD, LLP, 3000 EL CAMINO REAL, 5 PALO ALTO SQUARE, PALO ALTO, CA, 94306, US

(73) Assignee: Objects, S.A., Levallois-Perret (FR)

(21) Appl. No.: 11/267,041

(22) Filed: Nov. 4, 2005

Related U.S. Application Data
(63) Continuation-in-part of application No. 11/102,488, filed on Apr. 7, 2005.

(51) Int. Cl. G06F 17/27

(52) U.S. Cl. 704/9

(57) ABSTRACT

A computer readable medium storing executable instructions to deterministically construct a text question for application to a data source includes executable instructions to allow a user to specify a second language different than a first language used as organizational schema of a data source. Language rules are loaded for the second language. The language rules are used to translate an initial text question from the first language to the second language. A user is supplied with the initial text question in the second language. The user is allowed to alter a sentence component of the text question to form an altered sentence component. Executable instructions identify when the altered sentence component in combination with remaining sentence components creates an invalid question and supplies sentence components to insure selection of a valid question. A data source query is constructed from the initial text question and at least one altered sentence component. The data source query is applied to the data source to produce data results, which are presented to the user.

### CROSS-REFERENCES TO RELATED APPLICATIONS

This application is a continuation-in-part of the application entitled “Apparatus and Method for Deterministically Constructing a Text Question for Application to a Data Source”, Ser. No. 11/102,488, filed Apr. 7, 2005.

This application is related to the following concurrently filed, commonly owned patent applications, each of which is incorporated by reference herein:

Apparatus and Method for Data Modeling Business Logic, Ser. No. 11/102,613, filed Apr. 7, 2005;

Apparatus and Method for Utilizing Sentence Component Metadata to Create Database Queries, Ser. No. 11/102,477, filed Apr. 7, 2005; and

Apparatus and Method for Constructing Complex Database Query Statements Based on Business Analysis Comparators, Ser. No. 11/102,562, filed Apr. 7, 2005.

### BRIEF DESCRIPTION OF THE INVENTION

This invention relates generally to accessing digital data. More particularly, this invention relates to a technique for deterministically constructing a text question that can be converted to a data source query for application to a digital data source.

### BACKGROUND OF THE INVENTION

Business intelligence generally refers to software tools used to improve business enterprise decision-making. These tools are commonly applied to financial, human resource, marketing, sales, customer and supplier analyses. More specifically, these tools can include: reporting and analysis tools to present information; content delivery infrastructure systems for delivery and management of reports and analytics; data warehousing systems for cleansing and consolidating information from disparate sources; and, data management systems, such as relational databases or On Line Analytic Processing (OLAP) systems used to collect, store, and manage raw data.

Given the disparate roles performed by business intelligence tools and the vast amount of data that they are applied against, there are ongoing efforts to simplify their use. In their most successful manifestations, non-technically trained personnel can use business intelligence tools. To achieve this, it is important to insulate non-technically trained personnel from the complexities of the underlying data sources. Users of business intelligence tools generally have knowledge of the information that they want; the challenge is translating this knowledge into appropriate queries that can be applied to an underlying data source.

Ideally, a business intelligence tool provides an interface that allows a user to think on his or her own terms, but still allows for data source queries that can be efficiently applied against a data source. Since business intelligence users commonly think in terms of text-based queries, it would be desirable to provide such users with text-based queries that can be used directly and/or that can be used with user-selected modifications to the original text-based queries. Ideally, such a system would only permit the construction of text-based queries that can be converted into data source queries. Preferably, such a system would be extensible to support multiple languages.

### SUMMARY OF INVENTION

The invention includes a computer readable medium storing executable instructions to deterministically construct a text question for application to a data source. The computer readable medium includes executable instructions to allow a user to specify a second language different than a first language used as organizational schema of a data source. Language rules are loaded for the second language. The language rules are used to translate an initial text question from the first language to the second language. A user is supplied with the initial text question in the second language. The user is allowed to alter a sentence component of the text question to form an altered sentence component. Executable instructions identify when the altered sentence component in combination with remaining sentence components creates an invalid question and supplies sentence components to insure selection of a valid question. A data source query is constructed from the initial text question and at least one altered sentence component. The data source query is applied to the data source to produce data results, which are presented to the user.

The invention also includes a computer readable medium storing executable instructions to deterministically construct a text question for application to a data source using an organizational schema in a first language. The computer readable medium includes executable instructions to supply a user with an initial text question in a second language. The user is allowed to alter a sentence component of the text question to form an altered sentence component. The executable instructions identify when the altered sentence component in combination with remaining sentence components creates an invalid question and supplies sentence components to insure selection of a valid question. From the initial text question and at least one altered sentence component, a data source query is constructed by transforming the initial text question and at least one altered sentence component from the second language to the first language. The data source query is applied to the data source using the organizational schema in the first language to produce data results, which are presented to the user.

The invention provides a technique for text-based queries, which are familiar to all types of end-users. Advantageously, the invention supplies text-based queries to users and allows users to manipulate the text-based queries solely in ways that will result in a data source query. The invention is adaptable to support multiple languages.

### BRIEF DESCRIPTION OF THE FIGURES

The invention is more fully appreciated in connection with the following detailed description taken in conjunction with the accompanying drawings, in which:

FIG. 1 illustrates a computer constructed in accordance with an embodiment of the invention.

FIG. 2 illustrates processing operations associated with an embodiment of the invention.

FIG. 3 illustrates a simple question panel configured in accordance with an embodiment of the invention.

FIG. 4 illustrates the alteration of sentence components of the question panel of FIG. 3 in accordance with an embodiment of the invention.

FIG. 5 illustrates data results produced by the exemplary question panels of FIGS. 3 and 4.

FIG. 6 illustrates another question panel configured in accordance with an embodiment of the invention.

FIG. 7 illustrates the alteration of sentence components of the question panel of FIG. 6 in accordance with an embodiment of the invention.

FIG. 8 illustrates the selection of data result formatting options in accordance with an embodiment of the invention.

FIG. 9 illustrates data results produced by the exemplary question panels of FIGS. 6-8.

FIG. 10 illustrates an expression editor to produce personal filter criteria in accordance with an embodiment of the invention.

FIG. 11 illustrates various question templates that may be used in accordance with an embodiment of the invention.

FIG. 12 illustrates a computer configured in accordance with a multi-lingual embodiment of the invention.

FIG. 13 illustrates processing operations associated with a multi-lingual embodiment of the invention.

FIG. 14 illustrates sentence components equated in two languages in accordance with an embodiment of the invention

FIG. 15 illustrates sentence components and associated metadata utilized in accordance with an embodiment of the invention.

Like reference numerals refer to corresponding parts throughout the several views of the drawings.

### DETAILED DESCRIPTION OF THE INVENTION

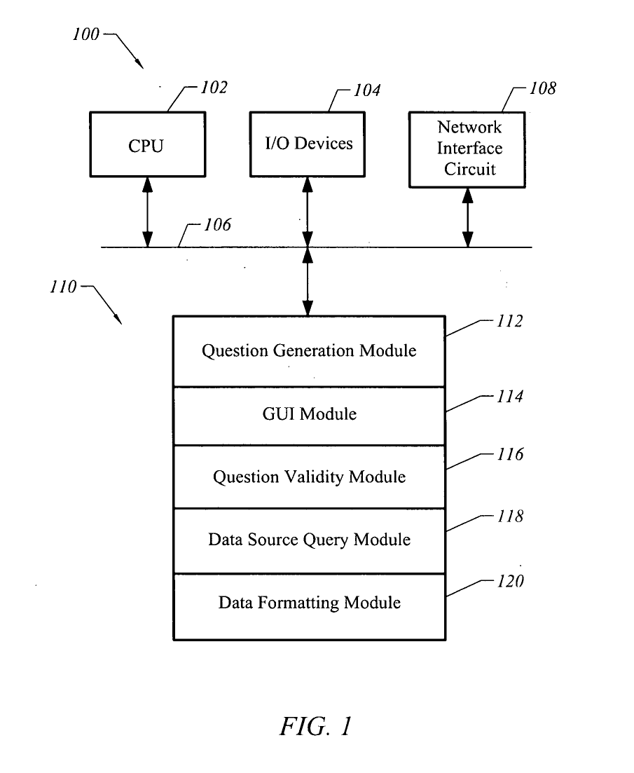

FIG. 1 illustrates a computer 100 configured in accordance with an embodiment of the invention. The computer 100 includes standard components, including a central processing unit 102 and input/output devices 104, which are linked by a bus 106. The input/output devices 104 may include a keyboard, mouse, touch screen, monitor, printer, and the like. A network interface circuit 108 is also connected to the bus 106. The network interface circuit 108 provides connectivity to a network (not shown), thereby allowing the computer 100 to operate in a networked environment.

A memory 110 is also connected to the bus 106. The memory 110 stores executable instructions to implement operations of the invention. In one embodiment, the executable instructions include a question generation module 112. The question generation module 112 includes executable instructions to provide an initial question to a user. The initial question may be supplied to the user through a default selection or through a previous specified question selection. Question selection may be predicated upon a template of questions. For example, the template of questions may be divided by enterprise function, such as marketing, finance, and the like. The question may also be based upon previous customized questions, either created by the user or by another user. Alternately, the question may be selected from a list of frequently asked questions or a list of recently asked questions. In one embodiment of the invention, predicted questions may be supplied based upon the previous behavior of a user or group of users. As discussed below, questions may be based upon personal filter criteria established by a user.

Memory 110 also stores a Graphical User Interface (GUI) module 114. The GUI module 114 may rely upon standard techniques to produce graphical components, such as pull-down menus, radio buttons, and the like, examples of which are discussed below.

Memory 110 also stores a question validity module 116. The question validity module includes executable instructions to insure that only valid questions are presented to a user or constructed by a user. In one embodiment, the question validity module includes executable instructions to insure that all displayed components form a valid question. A valid question is defined as a text question that can be translated to a legitimate data source query. In another embodiment, the question validity module includes executable instructions to insure that all selectable components (i.e., those displayed and those available for selection) form a valid question, regardless of the component combination. This may require the deletion of selectable components based upon previously selected components. Alternately, this may allow the addition of selectable components based upon previously selected components. In one embodiment, the question validity module 116 includes executable instructions to predict a complete text-based question based upon the selection of one or more selectable components. For example, the selection of two selectable components may result in the question validity module 116 generating a new text-based question with new components. The new components may be automatically selected based upon the previous behavior of the user or based upon the previous behavior of another group of users.

The question validity module 116 insures that in the dynamic operation of constructing a text-based query, only legitimate queries are generated. Thus, the module deterministically constructs a text question that will be successfully applied to a data source. This stands in sharp contrast to prior art techniques in which a text-based question is constructed, but might fail upon execution because of improper form and/or content. Such a run-time failure is advantageously prevented through use of the question validity module of the invention.

A data source query module 118 is also stored in memory 110. The data source query module 118 includes executable instructions to translate the final text-based query into a data source query, e.g., a Structured Query Language (SQL) query. As previously indicated, the question validity module 116 insures that only valid text questions are generated, therefore, the data source query module 118 is always in a position to translate a text-based query into a data source query. The data source query module 118 also includes executable instructions to apply the generated data source query to an underlying data source, which may form a portion of computer 100 or may be accessed as a separate networked machine through the network interface circuit 108.

The question validity module 116 and the data source query module 118 may be implemented in accordance with any number of techniques, including those described in the following concurrently filed, commonly owned patent applications, each of which is incorporated by reference herein: Apparatus and Method for Data Modeling Business Logic, Ser. No. 11/102,613, filed Apr. 7, 2005; Apparatus and Method for Utilizing Sentence Component Metadata to Create Database Queries, Ser. No. 11/102,477, filed Apr. 7, 2005; and Apparatus and Method for Constructing Complex Database Query Statements Based on Business Analysis Comparators, Ser. No. 11/102,562, filed Apr. 7, 2005.

Memory 110 may also store a data formatting module 120. The data formatting module includes executable instructions to produce user-selectable data output formatting options. The data output formatting options may directly correspond to displayed sentence components of the text-based question. In addition, the data output formatting options may include components that are not directly specified by the displayed sentence components, as will be illustrated below.

The executable modules stored in memory 110 are exemplary. It should be appreciated that the functions of the modules maybe combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

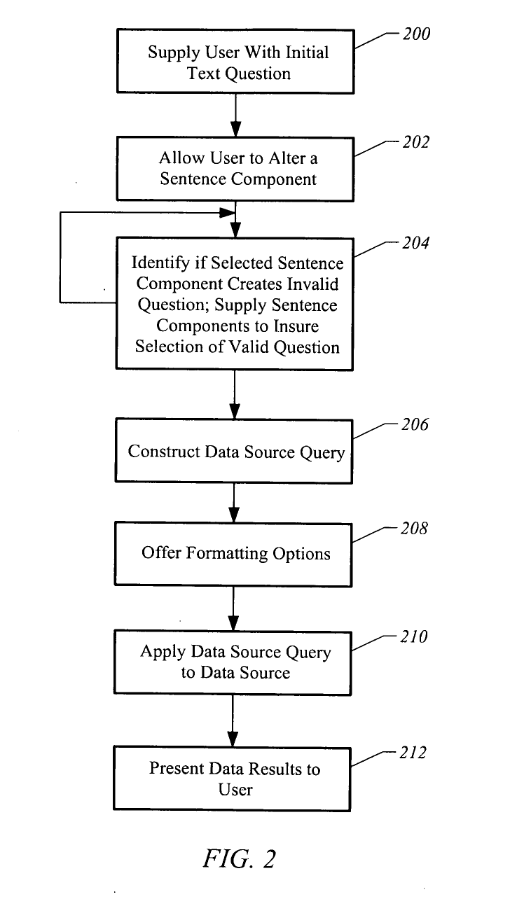

FIG. 2 illustrates processing operations that may be implemented by the computer 110. The first processing operation of FIG. 2 is to supply a user with an initial text question 200. The question generation module 112 may be used to implement this operation. As previously indicated, the initial text question may be generated from a template, previously customized questions, frequently asked questions, recently asked questions, and/or predicated questions.

The next operation of FIG. 2 is to allow a user to alter a sentence component 202. As will be shown through various examples below, alteration of a sentence component may be implemented through the use of pull-down menus. The GUI module 114 may be used to implement this operation.

The next processing operation of FIG. 2 is to identify if a selected sentence component creates an invalid question. If so, sentence components are supplied to insure the selection of a valid question 204. The question validity module 116 is used to implement this operation. As previously indicated, the question validity module 116 can be implemented to insure that all displayed components form a valid question. The question validity module 116 may also be implemented to insure that all selectable components potentially form a valid question, regardless of the combination of components. The operation of block 204 may be repeated until the user indicates that a final text-based question is prepared.

The next processing operation of FIG. 2 is to construct a data source query 206. This operation may be implemented using the data source query module 118. As previously indicated, the data source query module translates the text-based question into an equivalent data source (e.g., SQL) query.

An optional additional step is to offer formatting options 208. As will be illustrated below, the formatting options provide various user-selectable data presentation options to a user. The data formatting module 120 may be used to implement this operation.

The data source query (and the data formatting options, if selected) is then applied to a data source 210. The query module 118 may be used to implement this operation.

Finally, data results are presented to the user 212. The presentation operation may be implemented using the GUI module 114.

The apparatus and method of the invention has been fully described. Attention now turns to various specific examples to more fully illuminate the nature and benefits of the invention.

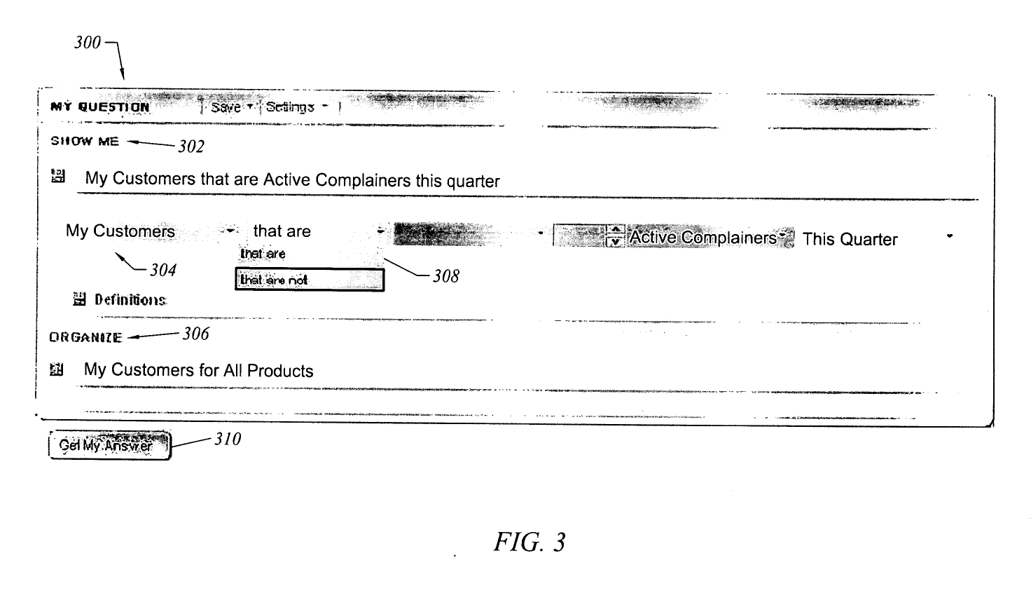

FIG. 3 illustrates a graphical user interface (GUI) 300 used to implement an embodiment of the invention. The GUI 300 includes a question panel 302, which displays a text-based question with selectable components 304. The GUI 300 also includes a formatting panel 306, which provides options for formatting data produced in response to the text-based query generated in the question panel 302.

FIG. 3 illustrates that a pull-down menu 308 is used to select components of the text-based question 304. By selecting a new component (e.g., “that are not”) in the pull-down menu 308, a new text-based question is formed. The question validity module 116 is then invoked to confirm that the selected components of the text-based question can be translated into a valid data source query. Alternately, the question validity module 116 may be implemented so that a valid data source query was insured by only supplying selectable data components that would produce a valid data source query.

In the example of FIG. 3, the text-based query includes a subject (i.e., “Customers”), a verb (i.e., “are”), a predicate noun (i.e., “complainers”), and a time period (i.e., “this quarter”). These are common components in the text-based queries utilized in accordance with embodiments of the invention. However, alternate and additional sentence components may also be used in accordance with embodiments of the invention.

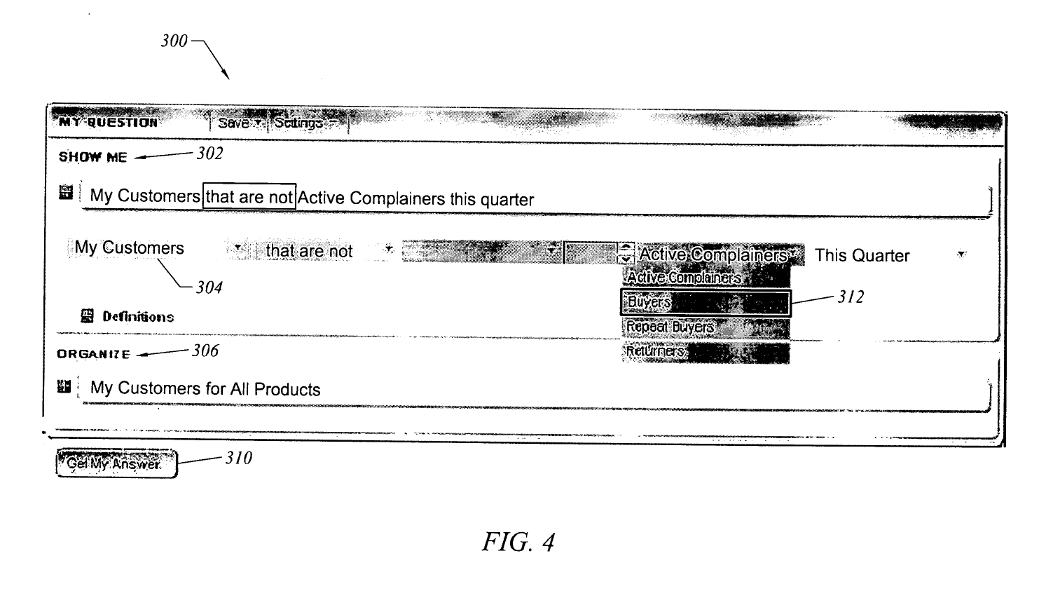

FIG. 4 generally corresponds to FIG. 3, but in FIG. 4 a pull-down menu 312 is activated for the selection of different selectable components (i.e., different predicate nouns, such as “buyers”, “returners”, etc.). The other sentence components also have associated pull-down menus, although not explicitly shown in this example.

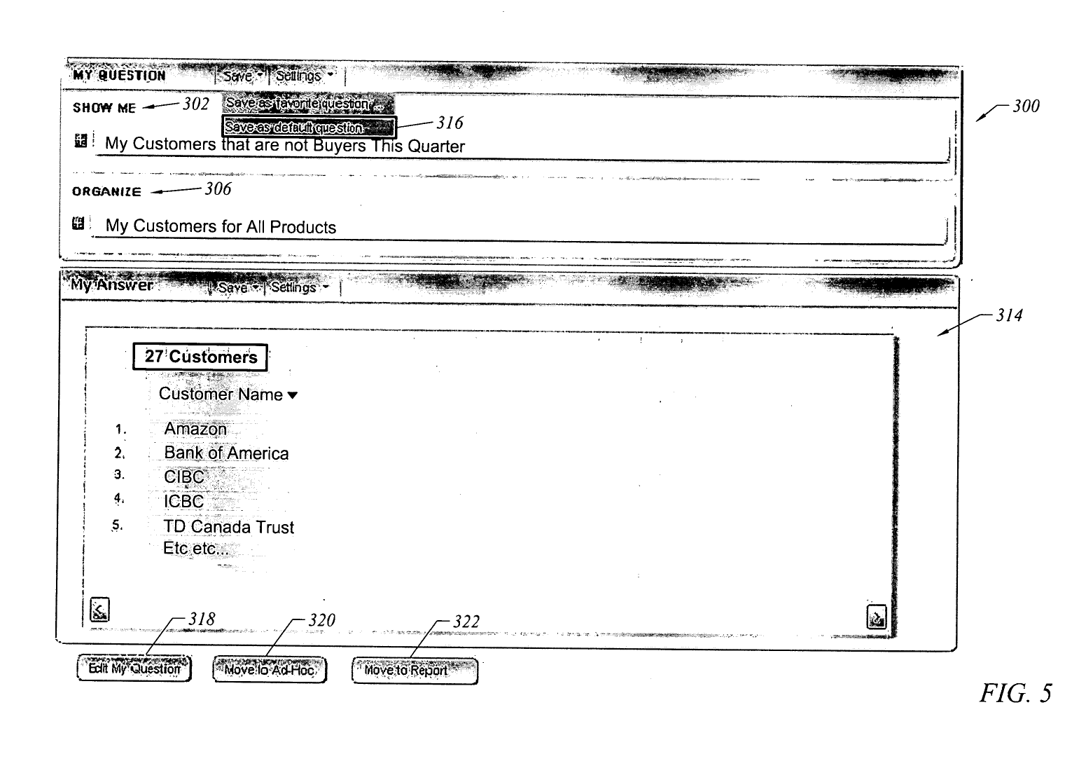

FIGS. 3 and 4 can be used to illustrate several of the processing operations associated with FIG. 2. For example, FIG. 3 illustrates that a user is supplied with an initial text question (block 200 of FIG. 2). FIGS. 3 and 4 illustrate that a user is allowed to alter one or more sentence components (block 202 of FIG. 2). When the “Get My Answer” button 310 is selected, a data source query is constructed (block 206 of FIG. 2) and is subsequently applied to a data source (block 210 of FIG. 2). FIG. 5 illustrates the result of this operation.

FIG. 5 illustrates the question panel 302 with the text-based question that was constructed, as shown in FIGS. 3 and 4. The figure also illustrates a results panel 314, which shows the results of the text-based query. FIG. 5 also illustrates that the question may be saved using pull-down menu 316. The pull-down menu 316 provides options, such as “Save as favorite question” and “Save as default question”. The question generation module 112 can then process this information. As previously discussed, the question generation module 112 is used to initially present a question to a user. The question may be presented based upon any number of criteria. In FIG. 5, a user's own previously customized question is saved as a default question for subsequent interactive sessions. The question generation module 112 may also present a question based upon a template, frequently asked questions, recently asked questions, predicted questions and the like.

FIG. 5 also illustrates an “edit my question button”. If selected, the user would be once again presented with a GUI, such as shown in FIGS. 3 and 4. A “Move to Ad-Hoc” button 320 and a “Move to Report” button 322 are also shown in FIG. 5. The “Move to Ad-Hoc” button 320 is used to move a question to an ad-hoc question repository. The “Move to Report” button is used to move the results information to a report that can be distributed.

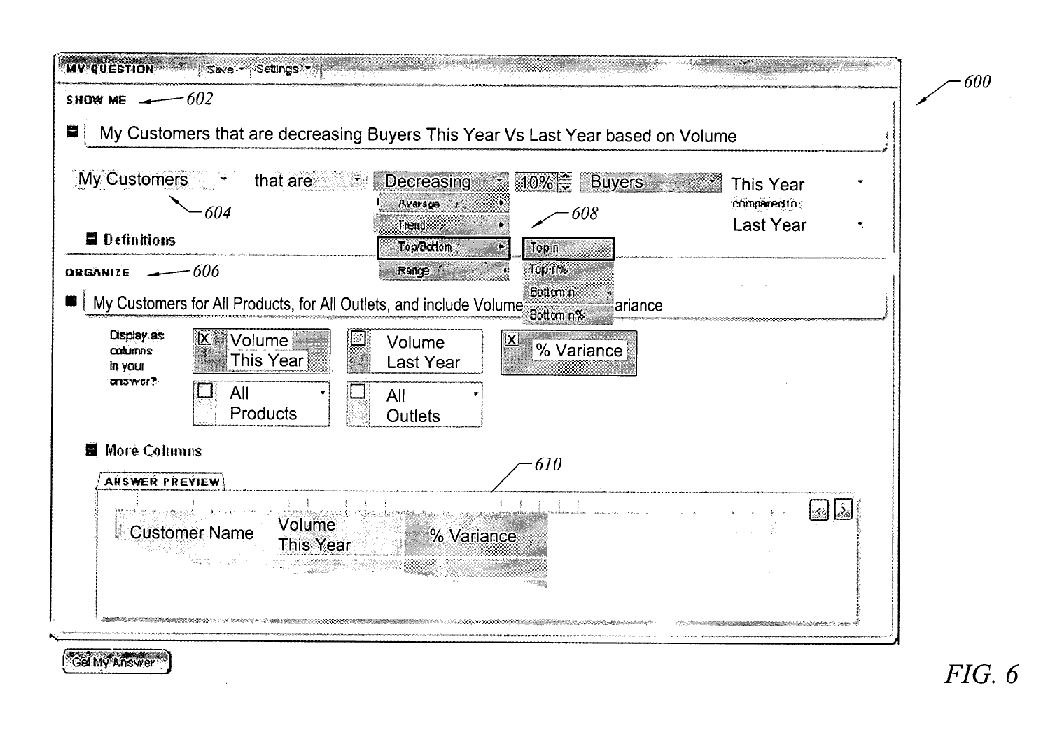

FIG. 6 illustrates another GUI 600 that may be used in accordance with an embodiment of the invention. The GUI 600 includes a question panel 602 with a text-based question 604. In this example, cascaded pull-down menus 608 are supplied for selectable components of the sentence 604. The formatting panel 606 in this example is more sophisticated than in the previous example. Observe that the formatting panel 606 has formatting options that correspond to selectable components of the sentence 604 (e.g., “Volume This Year”). The formatting panel 606 also has formatting options that do not appear in the selectable components of the sentence 604 (e.g., “All Products”). An Answer Preview field 610 provides a preview based upon the selections made in the formatting panel 606.

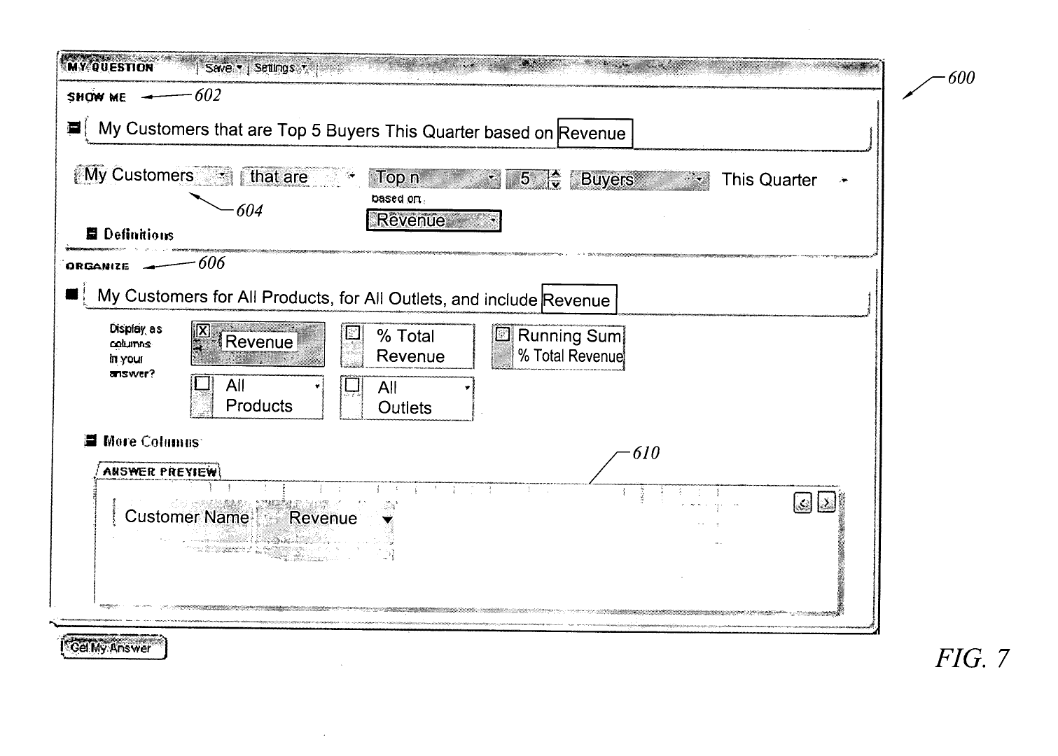

FIG. 7 generally corresponds to FIG. 6, but shows a different formed question 604, based upon the selections made in FIG. 6. The figure also illustrates a different Answer Preview 610 based upon the selections made in the formatting panel 606. The question generation module 112 may be used to create a new question, such as shown in FIG. 7, based upon previous selections, such as those made in FIG. 6. For example, the question generation module 112 may include executable instructions to identify instances when certain intermediate selections result in a certain final query. Subsequently, when the same intermediate selections are chosen, the question generation module 112 may automatically supply the certain final query. Any such predictive question may be altered through the selectable components, if necessary, to meet the user's current query objectives.

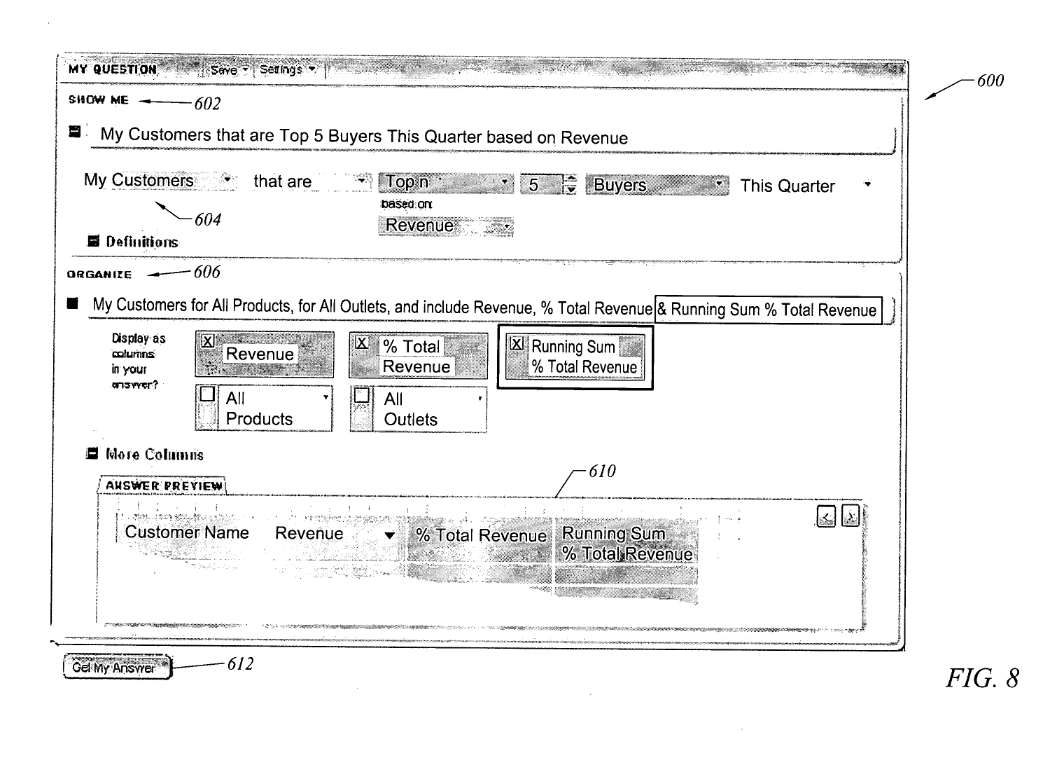

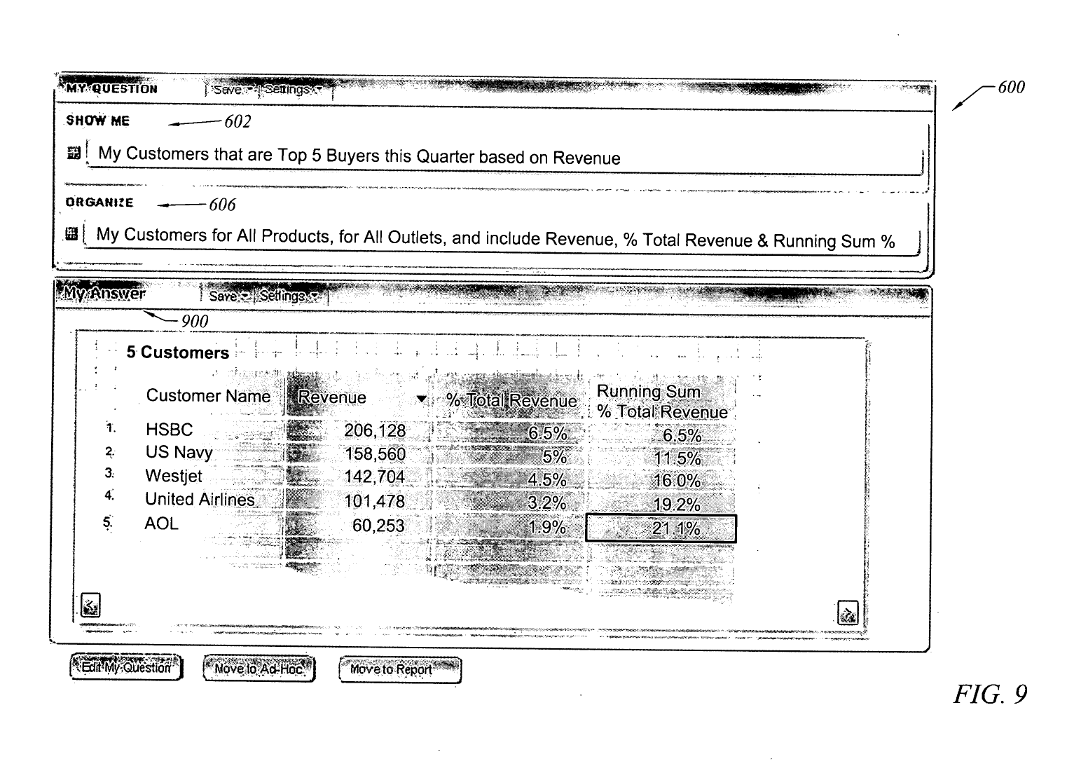

FIG. 8 generally corresponds to FIG. 7, but shows different selections made in the formatting panel 606. Thus, the Answer Preview field 610 has a different appearance. FIG. 8 also illustrates that the “Get My Answer” button 612 is highlighted for selection. This operation results in the production of an answer, as shown in FIG. 9. FIG. 9 illustrates the final question in question panel 602, the final organizational schema as shown in formatting panel 606, and the answer, as shown in answer panel 900.

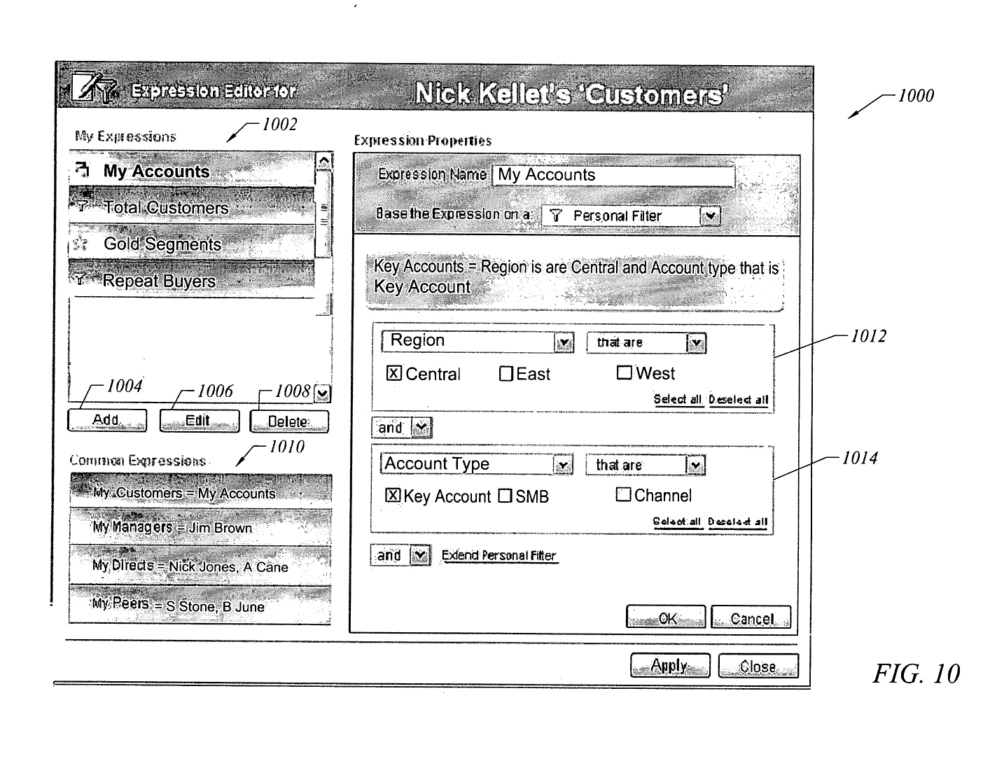

FIG. 10 illustrates an expression editor 1000 utilized in accordance with an embodiment of the invention. In this example, the expression editor is used to customize questions associated with a user's customers. A “My Expressions” block 1002 allows for the characterization of different customers. In this example, the customers are characterized as “My Accounts”, “Test Customers”, “Gold Segments”, and “Repeat Buyers”. Add, Edit, and Delete buttons, 1004, 1006, and 1008, respectively, are used to alter the contents of block 1002.

A “Common Expressions” block 1010 is also supplied. This block allows for alternate characterizations of customers. So, for example, the customers may be classified as customers of “My Managers”, “My Direct (Reports)”, and “My Peers”. The invocation of common expressions allows a user to access questions used by others in an organization.

FIG. 10 also illustrates that expression properties are configurable. As shown in FIG. 10 in block 1012, a central region may be designated as a region of interest. Characterization of an account may also be established through block 1014.

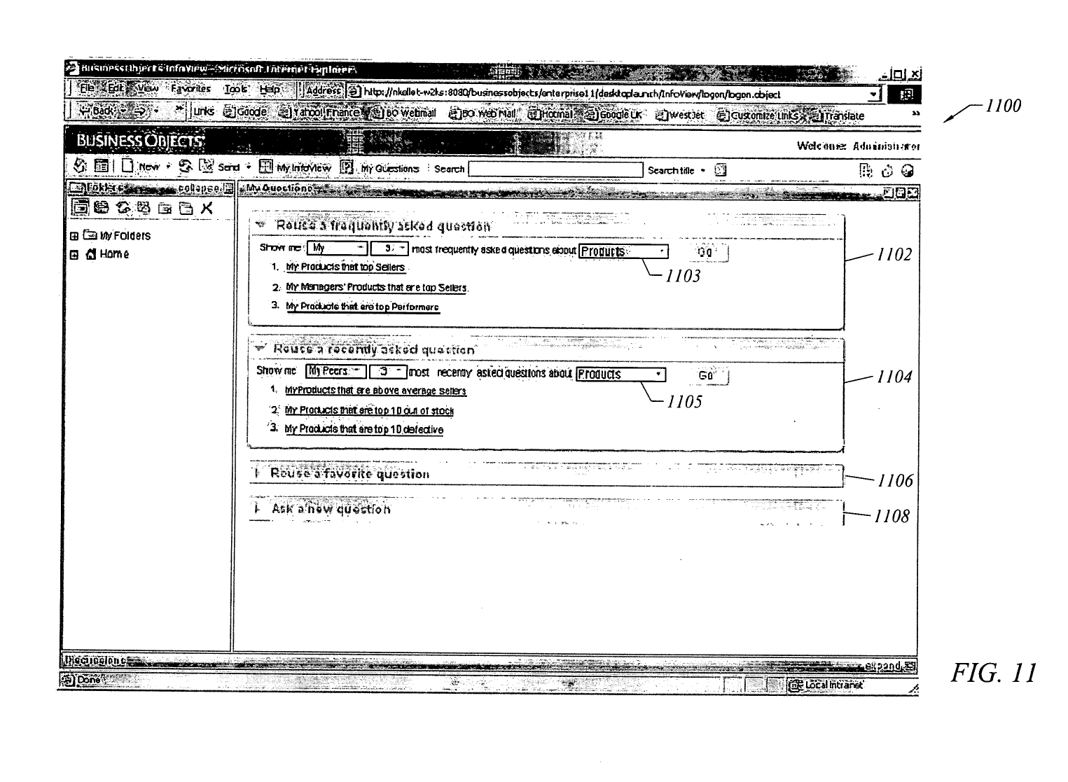

FIG. 11 illustrates a browser-based GUI 1100 that may be used in accordance with another embodiment of the invention. The GUI 110 includes a block 1102 specifying frequently asked questions. The questions shown in FIG. 11 are those of the user, but questions of another user may also be displayed. Observe the pull-down menus (e.g., 1103) that allow for alteration of the type of frequently asked question.

The GUI 1000 may be formed using the GUI module 114 in combination with the question generation module 112. In particular, the GUI module 114 may be used to control the visual appearance of the display, while the question generation module 112 may be used to supply and store expressions and expression properties.

FIG. 11 also shows a block 1104 specifying recently asked questions. In this example, the most recently asked questions relate to “My Peers 3 most recently asked questions about Products”. Thus, frequently asked questions of another are requested. Recall that “My Peers” was specified in block 1010 of FIG. 10. Pull-down menus (e.g., 1105) allow different types of recently asked questions to be presented.

FIG. 11 also illustrates a block 1106 for reusing a favorite question and a block 1108 to form a new question. The GUI 1100 may be formed using the GUI module 114 in combination with the question generation module 112. In particular, the GUI module 114 may be used to control the visual appearance of the display, while the question generation module 112 may be used to supply the various questions.

The invention provides for structured text-based questions, which are familiar to users. Note that the operation of the invention commences with an existing question. Thus, the user is not provided with a blank screen, which must be filled. Instead, the user has a starting point to direct his or her actions. The invention provides text queries that are limited (i.e., limited to the selectable components displayed) and mutually constraining (i.e., the selectable components are constrained to those components that will result in a valid query that can be applied to the data source). The question validity module 116 insures that only valid queries can be generated based upon the selectable components supplied to the user. Thus, based upon a set of currently selected components, the remaining selectable components maybe altered to insure that a valid query could be generated. The matrix of selectable components for any given text-query may be determined beforehand. Therefore, the invention can operate in a dynamic manner without significant computational expense.

The invention provides a visual and semantic metaphor to build questions to define sets of data. The visual and semantic metaphor allows non-technically trained users to obtain the data that they need in an intuitive manner. The question validity module 116 insures correct and unambiguous semantics at all times. Thus, run-time errors do not occur.

Many refinements of the disclosed technology are possible. For example, when a user alters a sentence component, the visible appearance of the altered sentence component may be modified (e.g., through highlighting, bolding, italics, different font, and the like). This allows the user to track and understand the impact of altering sentence components.

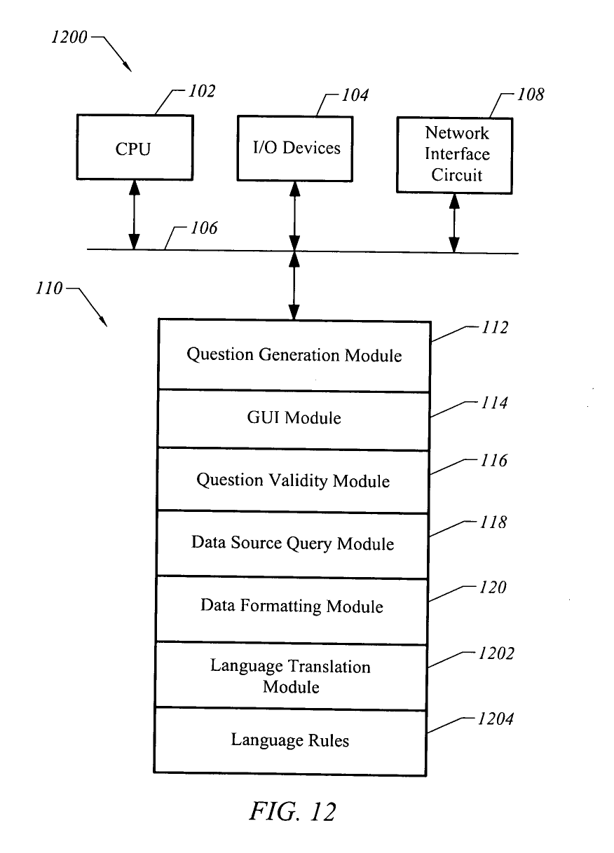

One advantage of the invention is its modular nature. This modularity allows additional modules to be added to extend the functionality of the invention. For example, the techniques of the invention are readily extendible to support multiple languages. FIG. 12 illustrates a computer 1200 configured to support a multi-lingual embodiment of the invention. The components of computer 1200 are the same as those of computer 100 of FIG. 1, except two additional modules of executable code are used to support multi-lingual functionality. A language translation module 1202 includes executable instructions to translate from a first language to a different language. The first language is the language used by the organizational schema of the data source. The different language may by any other language. The language translation module 1202 invokes a set of language rules 1204 to perform language translation operations between the first language and a different language. The language rules specify instructions to facilitate conversion of content in the first language to content in a second language. Each language has its own set of rules to effectuate this conversion. Preferably, the language translation module 1202 is configured to perform any language translation operation, depending upon the language rules that it invokes.

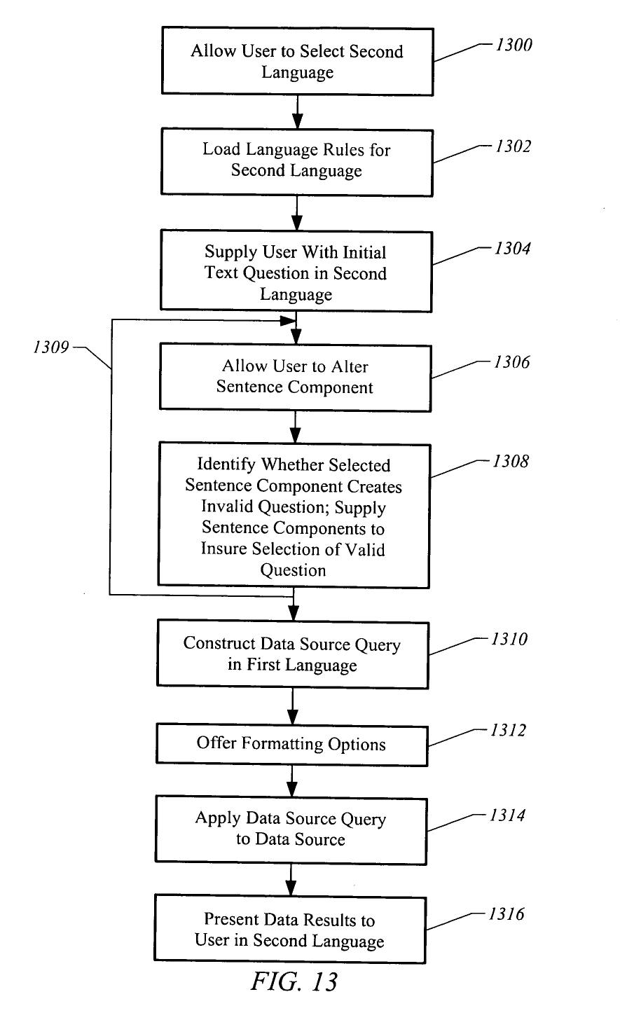

FIG. 13 illustrates processing operations associated with a multi-lingual embodiment of the invention. First, the user is allowed to select a second language 1300. The second language is any language other than the language used by the organizational schema of the data source. The organizational schema of the data source may include such things as column names, row names, etc.

Language rules are then loaded for the second language 1302. For example, if English is the first language used by the data source and French is the language selected by the user, French language rules would be invoked. The French language rules facilitate the conversion of English content to French content. The language rules typically include rules to translate sentence components, rules to enforce appropriate syntax in a sentence using the second language, and rules to enforce appropriate grammar in a sentence using the second language. The language translation module 1202 may invoke a set of language rules 1204 to implement this operation. As discussed below, the language translation module 1202 and the language rules 1204 may also be implemented to create a language-agnostic intermediate form, with individual languages being translated to the language-agnostic intermediate form.

The next operation of FIG. 13 is to supply a user with an initial text question in the second language 1304. Thus, for example, the language translation module 1202, operating with French language rules 1204 converts an initial text question in English to an initial text question in French. As previously indicated, the organizational schema of the first data source is in the first language (e.g., English). Similarly, the remaining executable components of the invention (e.g., the question generation module 112, the GUI module 114, the question validity module 116, etc.) operate in accordance with the first language. This embodiment of the invention leverages that functionality by creating translation mechanisms between the first language and the second language so that the functionality associated with the first language may still be used.

The next operation of FIG. 13 is to allow a user to alter a sentence component 1306. This is implemented in the same manner as previously described, except that the user is altering sentence components that are expressed in the second language (e.g., French).

The next operation of FIG. 13 is to identify whether a selected sentence component creates an invalid question and to supply sentence components to insure selection of a valid question 1308. To implement this operation, the language translation module 1202 uses the language rules 1204 to convert from the second language that the user is utilizing to the first language utilized by the data source. This allows the existing question validity module 116 to be used. As shown with arrow 1309, this process may be repeated.

Once the user is satisfied with his or her query, the system constructs a data source query in the first language 1310. Once again, the language translation module 1202 uses language rules 1204 to translate from the second language currently used to the first language used by the data source. By performing this translation, the original data source query module 118 may be used. The translation may be performed dynamically. Alternately, the translation may be statically set through a prior translation operation that is subsequently stored and accessed.

The next operation of FIG. 13 is to offer formatting options 1312. This may be implemented as in the prior embodiment, except that the user is offered formatting options in the second language. Again, the language translation module 1202 and the language rules 1204 may be used to alter the original GUI using English to an equivalent GUI using French. The data source query is then applied to the data source 1314.

Finally, the data results are presented to the user in the second language 1316. This operation entails another translation, this time from the first language to the second language. The translation may be performed statically or through reliance upon previous translation operations. The data source produces results formatted in accordance with the first language (e.g., column and row names of a report table in English). These results are then translated to the second language for presentation to the user. Observe that the data results may be in the first language or any other language. Alternately, the language translation module 1202 and language rules 1204 may be used to translate the data results from the first language to the second language, when possible.

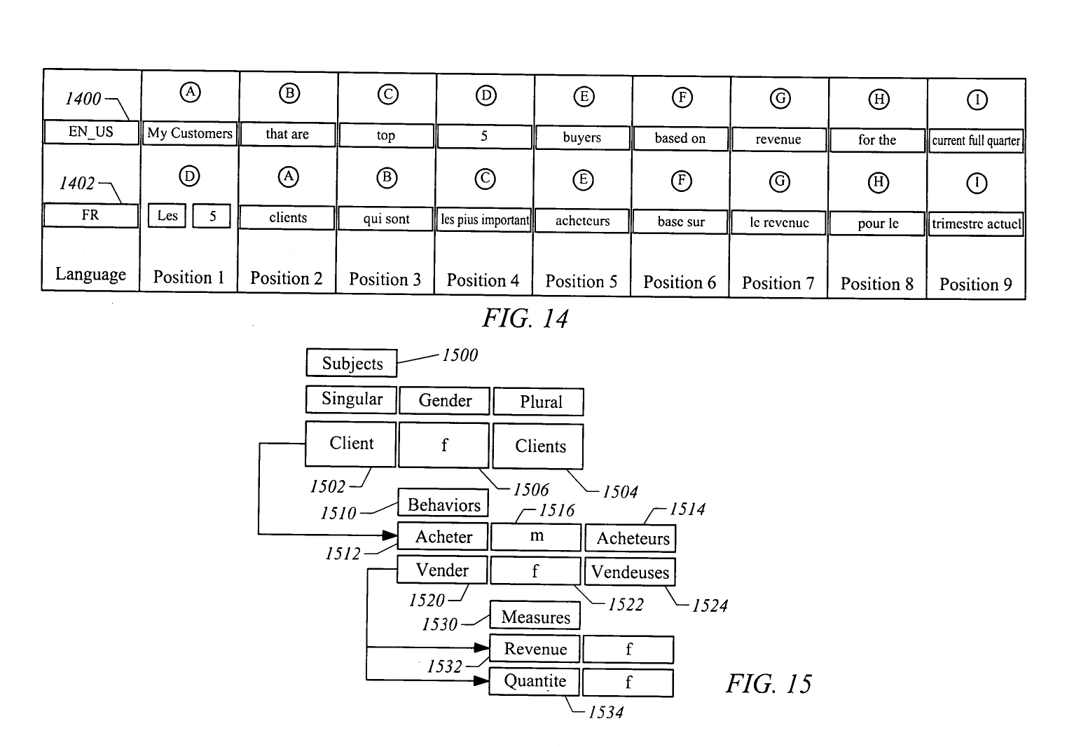

FIG. 14 illustrates an initial text question 1400 in a first language—English. The question has sentence components A-I broken down to nine positions, as shown. FIG. 14 also illustrates the initial text question translated to a second language—French. Once again, there are nine positions, but the sentence components A-I are no longer in alphabetical order. Instead, the order has been altered in view of syntax and grammar rules associated with the French language. The language translation module 1202 operating with a set of French language rules 1204 translates the original English text question into a French equivalent by relying upon French translation, syntax and grammar rules, as required. Additional language rules may be used to produce additional translations of the original English text.

FIG. 15 illustrates language rules in the form of metadata associated with sentence components of FIG. 14. The sentence component at position 1 of sentence 1400 is the subject “My Customers”. Block 1500 of FIG. 15 indicates that this component is a subject. Block 1502 provides a French translation for the singular form of the subject. Block 1504 provides a French translation for the plural form of the subject, and block 1506 indicates whether the subject is masculine or feminine.

FIG. 15 further illustrates that the subject is associated with a behavior (e.g., buyer in English) block 1510. The French translation for this behavior is provided in block 1512. The plural form is in block 1514 and the gender indicator is in block 1516. FIG. 15 also illustrates an associated behavior in block 1520 that may, for example, be supplied in a pull down menu. Block 1520 provides a French language equivalent for the English term seller. Block 1522 provides a gender indicator and block 1524 provides a plural form of the French term.

FIG. 15 further illustrates that the behavior 1510 is associated with a measure block 1530; in this example the measure is revenue. Block 1532 provides the French equivalent for the revenue measure, while block 1534 provides an alternate measure.

Metadata of this type may be used in accordance with embodiments of the invention. Observe in this case that translations may be made for existing questions in an offline manner. That is, dynamic translations need not be used. Instead, the language translation module 1202 and language rules 1204 may be used to create translations of existing questions prior to their invocation by a user. Similarly, the language translation module 1202 and language rules 1204 may be used to translate GUIs using the first language to GUIs utilizing the second language.

The language translation module 1202 and the language rules 1204 may be implemented to produce an intermediate, language-agnostic state, which is used to translate to any other language. This allows one to focus on encoding or translating each language into the language-agnostic state and then translate from this state back into all other languages. This approach presents scaling and efficiency advantages. Another advantage of this approach is that a question in the language-agnostic state may be directly translated into a data source query. Thus, a single data source query module 118 may be used.

Observe in FIG. 14 that a sentence is broken down into individual positions. Position information may be used to construct an intermediate, language-agnostic state. In addition, as shown in FIG. 15, the relationships between the sentence components and additional information, such as singular form, plural form, gender, and the like may be used to construct an intermediate, language-agnostic state for characterizing questions. Thereafter, individual languages are mapped to the intermediate, language agnostic state.

The invention may also be implemented such that the language translation module 1202 and the language rules 1204 are used to create a system that only uses a single language. Thus, for example, the organizational schema in the first language is changed to organizational schema in the second language. Therefore, all operations are performed in accordance with the second language. If another language is later selected, all operations will be performed in the accordance with the later selected language.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium storing executable instructions to deterministically construct a text question for application to a data source, comprising executable instructions to:
allow a user to specify a second language different than a first language used as organizational schema of a data source;
load language rules for said second language;
supply a user with an initial text question in said second language;
allow said user to alter a sentence component of said text question to form an altered sentence component;
identify when said altered sentence component in combination with remaining sentence components creates an invalid question and supplying sentence components to insure selection of a valid question;
construct from said initial text question and at least one altered sentence component, a data source query;
apply said data source query to said data source to produce data results; and
present said data results to said user.

2. The computer readable medium of claim 1 wherein said language rules include rules to translate a sentence component from said first language to said second language.

3. The computer readable medium of claim 1 wherein said language rules include rules to define syntax operations to observe when using a sentence component from said first language in a sentence of said second language.

4. The computer readable medium of claim 1 wherein said language rules include rules to define grammar tenets to follow when translating a sentence component from said first language to said second language.

5. The computer readable medium of claim 1 wherein said language rules are used to transform executable modules with graphical user interface information in said first language to corresponding executable modules with graphical user interface information in said second language.

6. The computer readable medium of claim 1 wherein said language rules include metadata associated with sentence components.

7. A computer readable medium storing executable instructions to deterministically construct a text question for application to a data source using an organizational schema in a first language, comprising executable instructions to:
supply a user with an initial text question in a second language;
allow said user to alter a sentence component of said text question to form an altered sentence component;
identify when said altered sentence component in combination with remaining sentence components creates an invalid question and supplying sentence components to insure selection of a valid question;
construct from said initial text question and at least one altered sentence component, a data source query, wherein the executable instructions to construct include executable instructions to transform said initial text question and at least one altered sentence component from said second language to said first language;
apply said data source query to said data source using said organizational schema in said first language to produce data results; and
present said data results.

8. The computer readable medium of claim 7 wherein said executable instructions to supply include executable instructions to supply a user with an initial text question with selectable components that are dynamically translated to said second language from said first language.

9. The computer readable medium of claim 7 wherein said executable instructions to identify include executable instructions to dynamically translate said altered sentence component and said text question from said second language to said first language.

10. The computer readable medium of claim 7 wherein said executable instructions to present include executable instructions to dynamically translate data result fields from said first language to said second language.

11. The computer readable medium of claim 7 further comprising language rules for translating from said first language to said second language.

12. The computer readable medium of claim 11 wherein said language rules include rules to define syntax operations to observe when using a sentence component from said first language in a sentence of said second language.

13. The computer readable medium of claim 11 wherein said language rules include rules to define grammar tenets to follow when translating a sentence component from said first language to said second language.

14. The computer readable medium of claim 11 wherein said language rules are used to transform executable modules with graphical user interface information in said first language to corresponding executable modules with graphical user interface information in said second language.

15. The computer readable medium of claim 11 wherein said language rules include metadata associated with sentence components.

16. A computer readable medium storing executable instructions to deterministically construct a text question for application to a data source using an organizational schema in a first language, comprising executable instructions to:
supply a user with an initial text question in a second language;
allow said user to alter a sentence component of said text question to form an altered sentence component;
identify when said altered sentence component in combination with remaining sentence components creates an invalid question and supplying sentence components to insure selection of a valid question;
construct from said initial text question and at least one altered sentence component, a data source query for application to said data source using said organizational schema in said first language;
apply said data source query to said data source to produce data results; and
present said data results.

17. The computer readable medium of claim 16 further comprising executable instructions to dynamically translate sentence components from said first language to said second language.

18. The computer readable medium of claim 17 wherein said executable instructions to dynamically translate include executable instructions to access language rules specifying translation, syntax, and grammar rules for translating between said first language and said second language.
